(19) United States
(12) Patent Application Publication
(10) Pub. No.: US 2003/0065618 A1
(43) Pub. Date: Apr. 3, 2003

(54) Method and system for electronic payroll advance and deposit

(76) Inventor: Frank W. VanDeBoe JR., Valrico, FL (US)

Correspondence Address: FOWLER WHITE BOGGS BANKER, P.A., 501 E. KENNEDY BOULEVARD, SUITE 1700, TAMPA, FL, 33602, US

(21) Appl. No.: 10/256,501

(22) Filed: Sep. 27, 2002

Related U.S. Application Data
(60) Provisional application No. 60/325,986, filed on Sep. 28, 2001.

(51) Int. Cl. G06F 17/60

(52) U.S. Cl. 705/40

(57) ABSTRACT

A payroll advance system wherein the Payroll Company receives from the Employers, or the Employer gathers itself, the data necessary to set up payroll, including employee identification and wage information, payroll deduction information, etc. The Payroll Company/Employer receives from the various Employees of the Employers applications for a payroll advance account and/or direct deposit of payroll funds. Since the Payroll Company/Employer already has access to much of the needed wage and personal information by virtue of managing payroll, the application process is greatly simplified for the Employees. Utilizing the Payroll Advance Application, along with the payroll data, the Payroll Company/Employer establishes a payroll advance limit for each pay period, and issues electronic Payroll Advance Cards to the qualified employees who requested the same. These cards can also be utilized to facilitate direct deposit of payroll funds, if desired.

### CROSS-REFERENCE TO RELATED APPLICATION

The present application claims the benefit of previously filed co-pending Provisional Patent Application, Serial No. 60/325,986.

### BACKGROUND OF THE INVENTION

A. Field of the Invention

The present invention relates generally to the field of payroll funds and, more particularly, to electronic payroll advances and deposits.

B. Description of the Related Art

A large number of employed individuals find themselves in need of funds between paychecks. Currently, many of these individuals utilize cash advance or payroll advance establishments to obtain the funds they need. Similarly, a large number of employed individuals do not have bank accounts, and must utilize check-cashing facilities to cash their paychecks. In order to utilize the currently available payroll advance or check cashing services, the consumer must locate such an establishment, travel to the establishment, and fill out the required paper work to obtain the funds. Thus, such consumers do not currently enjoy the convenience and privacy of electronic fund transfers.

The typical payroll advance transaction either involves the employee requesting an advance from the employer, or utilizing a cash advance or payroll advance establishment. Requesting an advance from the employer has several problems. First of all, many employers are unwilling to engage in this practice. Even when the employer is willing, the process is often humiliating to the employee. Further, it allows the employer to learn of the employee's private financial situation, and can cause relationship problems between the employee and employer that can jeopardize continued employment. In order to avoid the problems with employer advances, many employees in need of funds are forced to utilize cash advance or payroll advance establishments (hereinafter Advance establishments).

In a typical advance transaction with an advance establishment, the consumer must locate and travel to the establishment, which is inconvenient in terms of time and travel, and can also be a humiliating as there is no privacy. Once at the establishment, the consumer must provide proof of steady employment and reveal his or her income level, usually by providing a number of recent past payroll check stubs, and must also provide proof of a checking account at a viable financial institution. The establishment must then verify the steady employment, income level, and checking account, and based upon the information verified, determine the maximum amount that will be advanced, the duration of the advance, and the fee or interest to be charged to the consumer for the advance. Advances obtained under these present methods are considered high-risk loans and the borrowing consumer must therefore suffer a high interest rate or fee relative to the amount and duration of the loan. Further, the consumer must typically wait thirty minutes or more to receive the needed funds while the establishment verifies all of the information.

In many cases, particularly if the consumer does not have a checking account, the advance must typically be secured with some form of collateral, such as the title to a vehicle, electronics, jewelry, real estate, etc. If all goes well, the advance is timely repaid, and the procedure can be repeated each time the consumer is in need of an advance. Where collateral was used to secure the loan, the consumer must usually return to the establishment with the required repayment of the advance and interest in order to collect the collateral.

If the consumer fails to timely repay the loan, the loan can be extended, but the fees, again, are very high. Failure to repay can also result in loss of collateral, or other collection efforts that can be financially devastating to the consumer. Unfortunately, some consumers are financially undisciplined and can find themselves in this position under the present advance systems.

What is lacking in the art is a system or method in which consumers needing short term advances can obtain them without the humiliation, destruction of privacy, and inconvenience posed by the currently available systems. What is also lacking is a method to serve these consumers that can lower the risk to the advancing establishment such that the effective interest rate or fee is not as high.

Similarly, in the case of employees who do not have checking accounts, a system or method is needed which allows them to access the payroll funds that are normally paid via payroll check, without having to travel to a check cashing facility, pay an exorbitant fee, or wait for the funds. Although there have been previous attempts at direct deposit payroll debit cards to serve these consumers, this service has largely been abandoned due to the cost of providing same.

### SUMMARY OF THE INVENTION

Systems consistent with the present invention allow employees to obtain a payroll advance electronically via a payroll advance card that can be issued by establishments that process pay checks, credit card companies, or any other entity interested in doing same. Payroll advances, in amounts up to an advance limit set by the issuing establishment, can be made available in an electronic format such that the employee can utilize the convenience and privacy of ATM machines to obtain the advance in the form of cash, or point of sale units for direct purchasing power without first having to obtain the cash.

Systems consistent with the present invention also allow consumers who do not have checking accounts or deposit accounts with financial institutions to have their paycheck funds electronically transferred to the payroll advance card discussed above. Combining direct deposit with the payroll advance feature discussed above solves the problem of prohibitive cost for providing direct deposit since the issuing entity can obtain sufficient revenues from the payroll advance feature.

Systems consistent with the present invention benefit employees in need of payroll advances by providing the convenience and privacy of electronic transfers, and by reducing the risk associated with check cashing and payroll advance services and increasing the volume of such services such that fees for these services can be reduced.

The advantages and purposes of the present invention, as broadly described and embodied herein, include a system and method for providing electronic payroll advances and electronic transfer of payroll funds to employees via a magnetic Payroll Advance/Direct Deposit card, whereby the card issuer receives the employee's earnings information, establishes the periodic advance limit, maintains account balance information, authorizes withdrawals/debits, and recovers advanced amounts and associated fees by payroll deduction.

### DESCRIPTION OF THE DRAWINGS

FIG. 1 is a top level functional block diagram representing an implementation of the present invention.

FIG. 2 is a functional block diagram representing a system architecture for managing an implementation of the present invention.

FIG. 3 is a logic flow diagram depicting account management in accordance with an implementation of the present invention.

FIG. 4 is a detailed functional block diagram of a hardware architecture in accordance with an implementation of the present invention.

FIG. 5 shows an account database format consistent with an implementation of the present invention.

FIG. 6 shows a transaction data log format consistent with an implementation of the present invention.

### DETAILED DESCRIPTION OF THE INVENTION

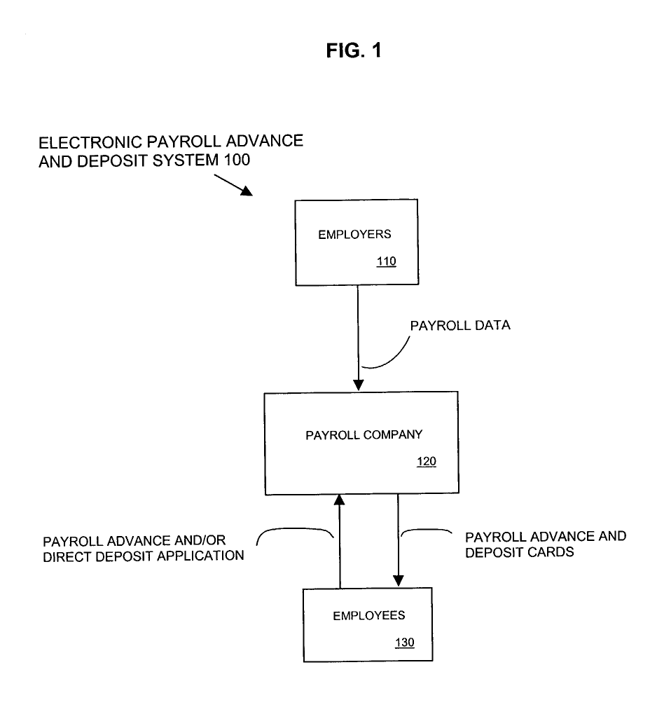

FIG. 1 is a block diagram of an implementation of an electronic payroll advance and deposit system 100 consistent with the present invention. This implementation is useful where the entity controlling the issuance of paychecks issues the payroll advance card. This system 100 includes one or more Employers 110, a Payroll Company 120, and one or more employees/consumers who have been issued electronic cards 130. In this implementation, the Payroll Company 120 manages the payroll for the one or more employers 110, issues the electronic cards, advances the funds and/or implements the direct deposit of payroll funds, and manages the advance and direct deposit accounts.

As FIG. 1 shows, the Payroll Company 120 receives from the Employers 110 the data necessary to set up payroll, including employee identification and wage information, payroll deduction information, etc. The Payroll Company 120 receives from the various Employees 130 of the Employers 110 applications for a payroll advance account and/or direct deposit of payroll funds. Since the Payroll Company 120 already has access to much of the needed wage and personal information by virtue of managing payroll, the application process is greatly simplified for the Employees 130. Utilizing the Payroll Advance Application, along with the payroll data, the Payroll Company 120 establishes a payroll advance limit for each pay period, and issues electronic Payroll Advance Cards to the qualified Employees 130 who requested the same. These cards are also utilized to facilitate direct deposit of payroll funds, if requested.

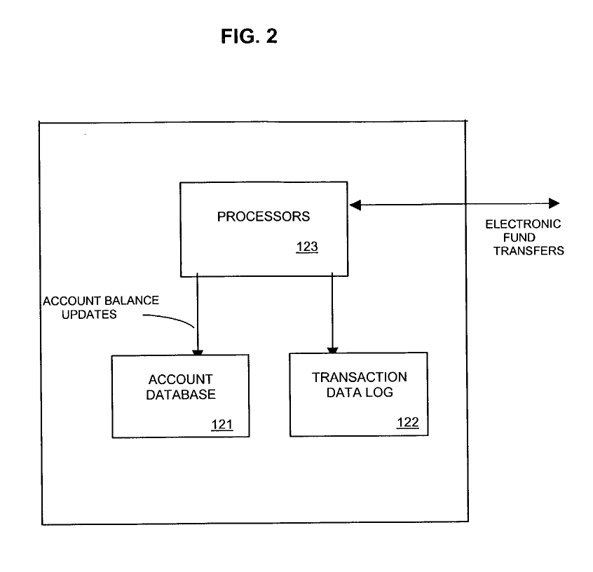

FIG. 2 is a block diagram that illustrates how the Electronic Payroll Advance and Deposit System 100 of FIG. 1 can be managed by the Payroll Company 120 in accordance with the present invention. The Payroll Company 120 maintains an Account Database 121 that contains the payroll advance account and deposit information for each Employee 130 that has been issued a card. This database contains the employee identification information, the account number for each employee's advance/deposit account, the advance limit per pay period for each account and/or the employee's periodic net earnings information, and the remaining available advance/deposit account balance. The Payroll Company 120 also maintains a Transaction Data Log 122 that reflects the chronological deposit and debit transactions for the account, and the applicable fees. One or more processors 123 facilitate the electronic transfer of funds to and from the account. These processor(s) also contain the logic to calculate the remaining account balances to be stored in the data base 121, and the advance fees to be deducted from the next pay period's earnings.

When it is time to issue pay checks, the data stored concerning the amount of available advance that was withdrawn or debited from the account during the previous period between paychecks, is utilized to determine the payroll deduction necessary to cover these amounts. The processor(s) 123 utilize the Transaction Data Log 122 data concerning the dates and amounts of payroll advances to calculate the advance fees, which are also collected by payroll deduction. The paycheck is then issued with these amounts deducted just like all other payroll deductions, and the Payroll Company 120 retains these amounts as repayment of the advance plus associated fees. The processor(s) 123 then update the database 121 to reflect the full advance limit available for the next period between paychecks, and the process begins again for the next period.

For employees 130 utilizing the direct deposit feature in addition to the advance feature, the process is the same except that the account balance will reflect not only the advance limit, but the net earnings that were directly deposited as well. For these accounts, the processor(s) 123 logic can apply the entirety of the direct deposit net earnings funds to withdrawals/debits before utilizing any advance funds. The database 121 can be structured such that account balance information will separately indicate net available earnings and net available advance funds.

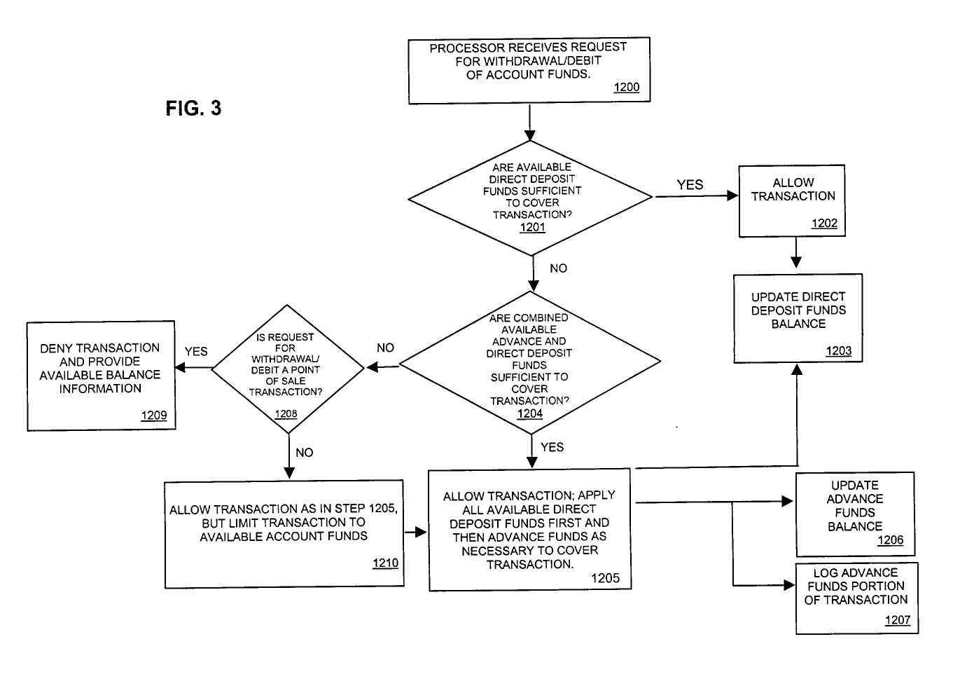

FIG. 3 presents a logic flow that will accomplish the above. Block 1200 represents a request for funds. This request can represent a point of sale transaction for goods or services, an ATM transaction, a balance transfer type of transaction, or any other type of transaction. The processor(s) 123 will then compare the amount of the requested transaction to the current remaining balance of direct deposit funds 1201 and determine if there are sufficient funds to cover the entire transaction. If yes, the transaction will be allowed 1202, all needed funds will be withdrawn/debited from the direct deposit funds and the direct deposit account balance will be updated 1203 to reflect the new remaining balance.

If at decision point 1201, the processor(s) 123 determines there are insufficient direct deposit funds to cover the entire balance, the processor(s) 123 will then compare the amount of the requested transaction to the current combined available advance and direct deposit funds balance 1204. If the combined balance is sufficient, the transaction will be allowed, utilizing all available direct deposit funds first, and then advance funds as necessary to cover the transaction 1205. The system then updates the direct deposit account balance, which will now reflect a zero balance 1203, updates the advance account balance 1206, and logs the advance transaction in terms of amount and date 1207 to facilitate calculation of advance fees at payroll time.

If at decision point 1204 there are insufficient combined account funds to cover the entire requested transaction, the system can utilize logic to determine if the requested transaction is a point of sale transaction for goods/services, or a cash transaction such as an ATM transaction 1208. A point of sale transaction can be denied for insufficient funds 1209, providing the insufficient funds account balance information, and a cash transaction can be allowed up to the extent of the available funds only 1210, completing the transaction per blocks 1205-1207.

The implementation depicted in FIGS. 1-3 and described above is but one way to practice the present invention. Those skilled in the art will appreciate that other entities, such as banks, credit unions, credit card companies, or any other entity with the requisite resources to provide the payroll advances, account management, and transaction authorizations and transfers contemplated by the present invention could serve as the card issuers. Entities such as credit card companies would have the advantage of already having the necessary electronic transaction systems in place to support the electronic transaction features. The disadvantage for utilizing such entities as the card issuer, is that these entities would not be in direct possession of the necessary payroll information to determine advance amounts and eligibility, and would therefore have to receive such information, either electronically, or in hard copy form, from employers or payroll companies. Those skilled in the art will also recognize that more than one entity could partner in issuing cards, managing accounts, providing advances, etc.

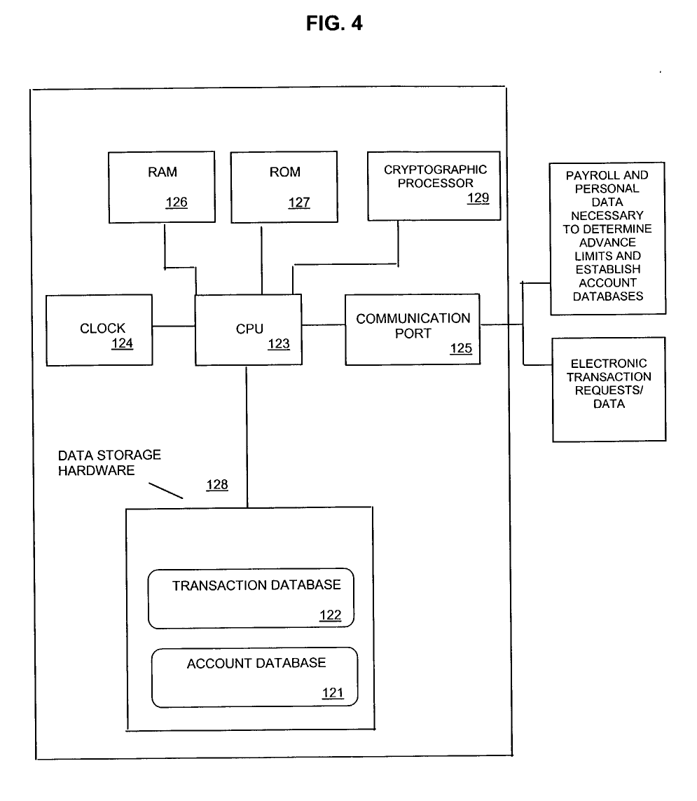

In another implementation, employers themselves could serve as the card issuer. Those skilled in the art will also recognize that a variety of database, information system, and electronic fund transfer system architectures could be utilized to accomplish the present invention. One implementation is disclosed in FIG. 4, which depicts an architecture that receives payroll and advance account/direct deposit application information, maintains the appropriate databases, authorizes transactions, and supports the interfaces with outside entities such as ATM machines and point of sale (credit card) machines. This implementation architecture includes a Central Processing Unit (CPU) 123 coupled to Random Access Memory (RAM) 126, Read Only Memory (ROM) 127, a clock 124, a communication port 125, and data storage hardware 128. The Communication Port couples the CPU to the external interfaces necessary to support ATM, point of sale, bank, or other electronic transactions. A cryptographic processor 129, well known in the art of secure electronic transfers, can be utilized to generate encrypted identification or transaction numbers to provide security. Those skilled in the art will recognize many system architecture variations that will fall within the scope of the present invention.

Those skilled in the art will also recognize that the logic utilized to maintain account balances, authorize or deny transactions, implement fund transfers, etc., can be accomplished in a variety of ways, and the logic presented in FIG. 3 is but one implementation consistent with the present invention. For example, a particular individual could have only direct deposit funds or only advance funds in their account, such that logic to decide which funds to utilize in a given transaction would be unnecessary. Also, the accounts need not be managed to ensure that direct deposit funds be utilized first, to practice the present invention.

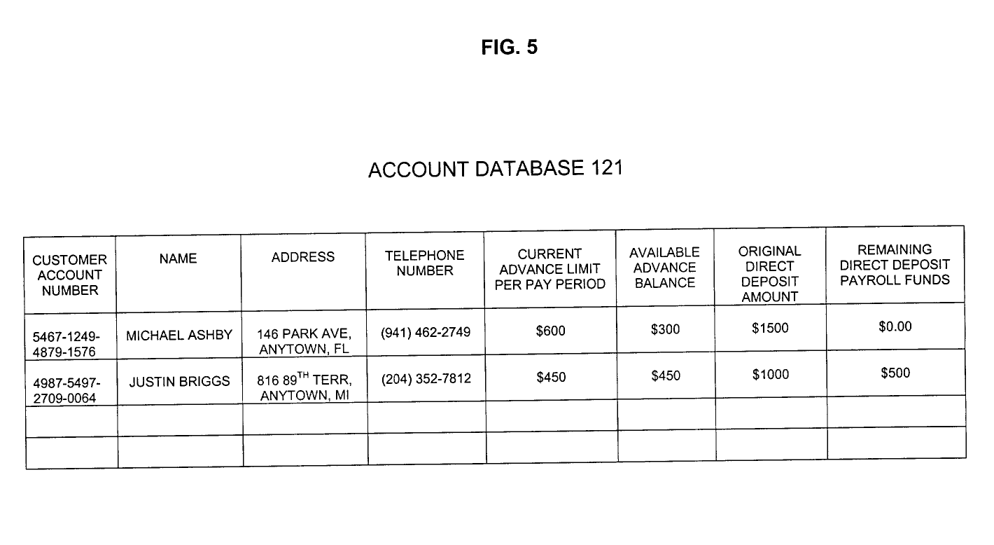

The Account Database 121 of the present invention can also take many forms. In one implementation, it would be structured utilizing standard business logic such as XML, to represent the data presented in FIG. 5 for an employee utilizing both direct deposit of payroll funds and payroll advance.

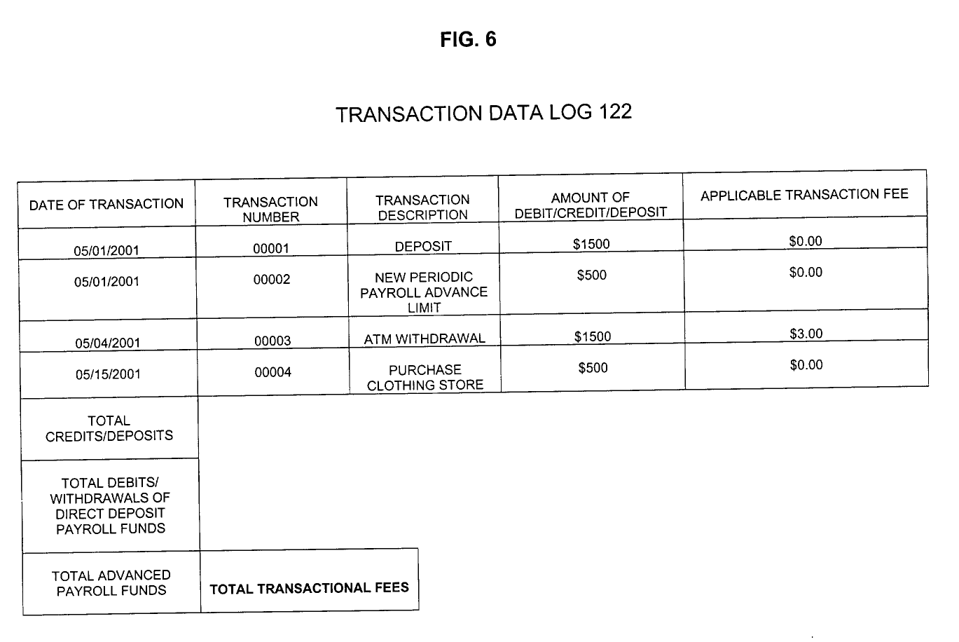

FIG. 6 shows a transaction data log consistent with the present invention that would be generated in hard copy for the employee: In a preferred implementation, this hard copy would be generated from the same Transaction Database 122 utilized by the CPU 123 to calculate fees. The total debits/withdrawals of advance funds, along with the associated fees, would also appear on the employee's pay stub (not shown) as payroll deductions.

The manner in which fees are calculated would be as determined by the issuing entity and market constraints, and is not within the scope of the present invention although any similar payroll advance system that calculates fees would be considered within the scope of the present invention.

Other features and options could be provided in a system or method consistent with the present invention. For example, employees could request limits below available advance limits that the issuing entity would allow. The issuing entity could automatically alter the available advance limit per pay period based upon changes in employee status, such as changes in income level, part-time versus full-time employment, temporary versus permanent employment, etc.

That which is claimed:

1) A payroll advance system consisting of:
An Account Database;
A Payroll Advance Card;
One or more Employee Advance Accounts;
Said one or more Employee Advance Accounts having account numbers and containing account information such as deposits, the advance limit per pay period and/or the employee's periodic net earnings information, and the remaining available advance/deposit account balance for each employee that has been issued said Payroll Advance Card;
Said Account Database containing said one or more Employee Advance Accounts and employee identification information relating one or more employees to said account numbers for said one or more Employee Advance Accounts;
A Transaction Database;
Said Transaction Database containing the chronological payroll earnings deposits and any debit transactions using said Payroll Advance Card for said one or more Employee Advance Accounts;
One or more Processors;
Said one or more Processors used to accomplish the electronic transfer of funds by payroll earnings deposits or debits resulting from use of said Payroll Advance Card to and from the said one or more Employee Advance Accounts; and,
Said one or more Processors are also capable using said Transaction Database in calculating account balances of said one or more Employee Advance Accounts in said Account Database and further calculating any payroll advance amounts to be paid back by deductions from future payrolls.

2) The payroll advance system of claim 1 wherein said one or more Employee Advance Accounts in said Account Database is structured such that account balance information in said one or more Employee Advance Accounts is capable of separately indicating available payroll earnings and available advance funds limits such that debit transactions using said Payroll Advance Card are withdrawn from available payroll earnings first.

3) The payroll advance system of claim 1 wherein said one or more Processors is also capable of calculating fees for employee use of the system and deducting said fees from said one or more Employee Advance Accounts.

4) The payroll advance system of claim 1 wherein said one or more Processors is capable of cryptographic processing such that said one or more Processors can generate encrypted identification or transaction numbers to provide security.
